(19) United States
(12) Patent Application Publication
(10) Pub. No.: US 2012/0037445 A1
(43) Pub. Date: Feb. 16, 2012

(54) METHOD FOR CREATING AN IMPROVED SWEEP FOR A SEISMIC SOURCE

(75) Inventors: Peter M. Eick, Houston, TX (US); Joel D. Brewer, Houston, TX (US); Shan Shan, Houston, TX (US); Frank D. Janiszewski, Richmond, TX (US)

(73) Assignee: ConocoPhillips Company, Houston, TX (US)

(21) Appl. No.: 13/191,970

(22) Filed: Jul. 27, 2011

Related U.S. Application Data
(60) Provisional application No. 61/372,327, filed on Aug. 10, 2010.

(51) Int. Cl. G01V 1/04

(52) U.S. Cl. 181/121

(57) ABSTRACT

An adapted seismic vibrator for obtaining a true ground force comprising: a baseplate pad; a baseplate drive system, wherein the drive system is connected to the baseplate pad and moves the baseplate pad up and down; a vibrator controller electronics, wherein the electronics are connected to the drive system and causes the drive system to move the baseplate pad up and down; and a plurality of load cell sensors disposed between the baseplate pad and ground, wherein the sensors measure the vibrator output force during a sweep. A method of obtaining a true ground force sweep comprising the steps of: using the load cell sensors to measure an actual output force of a seismic vibrator and electronics to obtain an actual ground force data; using inversion to invert the actual ground force data and desired original pilot sweep to obtain a revised pilot sweep that produces a true ground force sweep; and entering the true ground force sweep into the electronics.

### CROSS-REFERENCE TO RELATED APPLICATIONS

This application is a non-provisional application which claims benefit under 35 USC §119(e) to U.S. Provisional Application Ser. No. 61/372,327 filed Aug. 10, 2010, “Method For Creating An Improved Sweep For A Seismic Source,” which is incorporated herein in its entirety.

### STATEMENT REGARDING FEDERALLY SPONSORED RESEARCH OR DEVELOPMENT

None.

### FIELD OF THE INVENTION

This invention relates to the acquisition of seismic data and especially to sweep-type vibratory sources that provide seismic energy into the ground and create reflections from subsurface geology that is received and recorded in the form of seismic data.

### BACKGROUND OF THE INVENTION

Historically, the acquisition of seismic data was accomplished by creating an explosion that propagated a broad frequency spectrum of seismic energy into the ground. The energy carried down into the ground reflecting and refracting off and through the various strata below the surface and the returning wavefield was recorded. This type of seismic acquisition was slow and dangerous.

In the 1950's, Conoco developed sweep-type vibrators that reduced the energy intensity of the explosion by spreading the smaller energy over a longer period of time as shown in U.S. Pat. Nos. 2,688,124, 3,024,861, 3,073,659, 3,159,233, 3,209,322, and 3,293,598, etc., for example. This certainly improved safety while still providing a frequency spectrum of energy into the ground. Sweep-type vibrators have now been in common use for over 50 years. The seismic surveys accomplished with sweep-type seismic sources are reliable and consistent and, most importantly, are safer than taking explosives into the field. However, it has long been recognized that high frequency energy provides a level of detail in the seismic record that is highly desirable, but the intensity or amplitude of the high frequency energy in the data record has been less than desirable.

Conventional efforts to increase the recordable high frequency energy have been primarily focused on providing longer sweeps or to lengthen the proportion of the sweep time for which the higher frequency energy is delivered into the ground ie: manipulating the dwell or gain of the sweep. As a sweep-type vibrator delivers the seismic energy into the ground, it records each sweep and computes an approximate ground force delivered into the ground for use by a feedback circuit to control the vibe. This ground force approximation is used in subsequent analysis in seismic data processing. Conventional vibrator technology uses a weighted-sum method to approximate the “ground force” during a sweep. In 1984, Sallas derived the weighted-sum method to approximate the true ground force. See J. J. Sallas, Seismic Vibrator Control and the Downgoing P-Wave, GEOPHYSICS 49(6) (1984) 732-40. The weighted-sum method assumes that a baseplate acts as a rigid body, and that a full coupling between the baseplate and the ground is achieved. Under these assumptions, the weighted-sum ground force is obtained by summing the weighted baseplate and reaction mass accelerations. The Sallas approximation or equation may be written as:

−F_{g}=MᵣAᵣ+M_{b}A_{b},

where Mᵣ=Mass of the reaction mass (kg); M_{b}=Mass of the baseplate (kg); Aᵣ=Reaction mass acceleration (m/s²); A_{b}=Baseplate acceleration (m/s²); and F_{g}=Compressive force exerted on the earth by the baseplate (N). This is normally reported as the ground force of the vibrator.

The dynamics of vibrator systems seems to inherently limit the power that is deliverable into the ground at high frequency. A low frequency is delivered by a longer, slower stroke of the reaction mass while at a higher frequency, the baseplate stroke is fast and typically much shorter in length. While the Sallas approximation indicates that a fast stroke of shorter length provides equal force to the ground, the absence of the higher frequency data in the data traces or records from the field could mean that either the true force is not what is approximated by the Sallas equation or that consistent force across a broad frequency spectrum does not create a consistent source energy delivery across a broad frequency spectrum.

### BRIEF SUMMARY OF THE DISCLOSURE

The invention more particularly relates to a method for delivering a preferred seismic sweep from a seismic vibrator source into the ground in a survey area, where the ground force delivered by the seismic vibrator provides data with a broader bandwidth. The method includes providing a first seismic vibrator having a baseplate, a baseplate drive system connected to the baseplate to move the baseplate up and down, and a vibrator controller apparatus to control the baseplate drive system and providing at least one sensing device independent of the seismic vibrator to measure the force the baseplate applies against the ground. The seismic vibrator source is actuated via the vibrator controller to deliver at least one desired original pilot sweep through the sensing device to the ground measuring and recording the actual force output of the source. The actual output force is compared to the original desired pilot sweep and a suitable inverse function is created a between the recorded force data as measured by the sensing device and the desired pilot sweep by computing a pilot modification function and analyzing the pilot modification function for suitability for use with the seismic vibrator system and modifying the revised pilot sweep, if necessary, for such suitability. The revised pilot sweep is then used as the standard sweep in the acquisition of seismic data in the survey area in a conventional manner without using the load sensing devices at every source location.

### BRIEF DESCRIPTION OF THE DRAWINGS

A more complete understanding of the present invention and benefits thereof may be acquired by referring to the follow description taken in conjunction with the accompanying drawings in which:

FIG. 1 is a cross-sectional view of the operational portion of a conventional seismic vibrator on load cell tiles; and

FIG. 2 is a flow diagram of the process for creating an improved pilot sweep for a sweep-type vibratory seismic source to use to put seismic energy into the earth.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

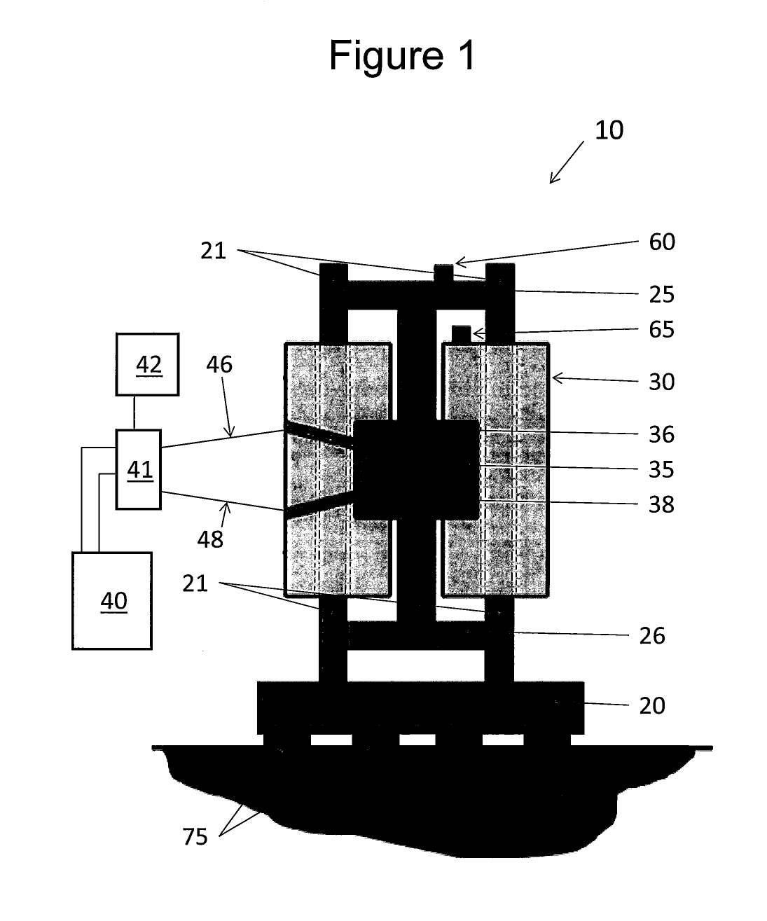

As noted above, it has been difficult to acquire suitable high frequency data when using sweep-type vibratory seismic sources and investigations pursuant to the present invention have turned toward an analysis of the energy that sweep-type vibratory seismic sources are actually putting into the ground in hopes of increasing the presence of high frequency data in the returning wavefield. The analysis begins with a seismic vibrator that one would plan to use in a seismic survey. For explaining the invention, a conventional sweep-type vibratory seismic source is illustrated in FIG. 1 and is now explained.

A simplified version of the operable portion of a conventional seismic vibrator is generally indicated by the arrow 10. The primary operative element is baseplate 20 that is lowered to the ground 55 and held down typically using the weight of the vehicle that carries vibrator 10. Typically, vibrator 10 is carried along under the belly of the vehicle and lowered to the ground once located at a shot point or source point. While the weight of the vehicle is used to hold the baseplate to the ground, it is typically isolated from the intense vibration by pneumatic dampeners that are not shown. The second operative element of the vibrator is reaction mass 30 that is positioned to slide up and down along guide rods 21. The reaction mass 30 is a heavy and substantial sized block of metal. The reaction mass 30 is intended to be forcefully moved up and down to create impulses that are passed into the ground 55 through baseplate 20.

The reaction mass 30 is driven up and down along guide rods 21 by a hydraulic system, schematically indicated by box 40, where hydraulic fluid is delivered through a valving system 41 and into and through channels 46 and 48. Upper and lower cylinders 36 and 38 are rapidly filled and drained of hydraulic fluid to drive the reaction mass 30 relative to piston 35. Vibe controller 42 controls the valving system 41 thereby controlling the speed and direction of the reaction mass and ultimately the frequency and force at which the reaction mass moves. The hydraulic system 40 typically includes a diesel powered hydraulic pump. As noted above, this is the basic arrangement of a conventional sweep-type vibrator. A baseplate accelerometer 60 measures the acceleration of the baseplate 20 while a reaction mass accelerometer 65 is mounted on the reaction mass 30 to record the acceleration of the reaction mass 30. Continuing with the discussion of the analysis of the seismic source, the vibrator 10 is operated to generate seismic energy, but using one or more load sensors between the baseplate 20 and the ground. As shown in FIG. 1, an array of load sensors 75 are placed under the baseplate 20 to more accurately measure the true ground force produced at each frequency to determine the actual ground force (F_{g}) applied to the earth over a range of frequencies. Load sensors are described in the publication “Load Cell System Test Experience: Measuring the Vibrator Ground Force on Land Seismic Acquisition”, Shan, S., et al. SEG Expanded Abstracts, 0016-0020 (October 2009) Although it is known that vibes provide a ground source estimate that is used for inversion and subsequent data processing, it turns out that current vibrators do not provide accurate information about the ground force actually delivered to the ground. The load sensors provide more accurate data and this has been confirmed by experiments using seismic receivers installed in boreholes deep in the ground. It should be emphasized that these experiments confirmed two important observations. First, the vibrators do not actually and consistently impart the ground force to the earth they report based on the ground force data computed by the vibrator controller based on the Sallas estimation, especially at higher frequencies. And secondly, the load sensors provide a relatively accurate ground force measurements across the frequency spectrum.

The information provided by the vibrator controller is sufficiently accurate at lower frequencies, but inaccuracy begins at about 35 Hz and continues to deviate as the frequency being delivered gets higher. The actually becomes unacceptable under most conventional ground conditions at frequencies of about 40 to 50 Hz in the sweep for most terrains using industry standard 60,000+ lbs vibrators. Specifically, most large industry standard seismic vibrators begin to reduce the actual ground force at about 35 Hz (as compared to what the vibrator actually reports via the vibe controller and the Sallas Approximation), and the ground force is quite variable above about 40 to 50 Hz. Much above 60 Hz and the forces in the sweeps are highly unstable and do not reflect the signal that is desired to be imparted to the ground and as reported by either the load cell data nor the data from the receivers in the well bore. In more simple and brutal terms, the vibe reports it is doing the sweep nearly perfectly but it is actually doing a terrible job putting the sweep into the ground. Essentially, the vibrators “lie” about how good of a job they are doing.

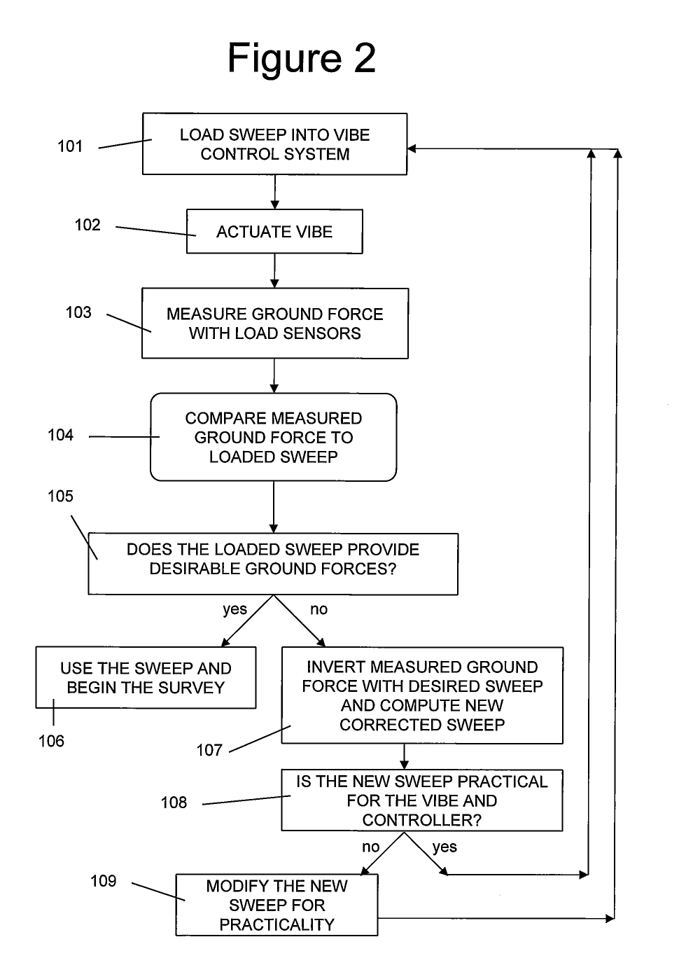

In a preferred embodiment, the true ground force imparted to the earth from a seismic vibrator is recorded using a load sensor device or an array of load sensor devices. The seismic vibrator controller electronics 42 is supplied a pilot sweep that represents the desired source signature at step 101 in FIG. 2. The pilot sweep is a sinusoidal function that varies in frequency with time. It is used by the vibrator control electronic system as a representation for the desired motion of the baseplate 20 and reaction mass 30. The motion of the baseplate 20 is then translated into ground force through impulses with the earth. Ground force is actually weight that varies in time in a similar manner to the way the pilot sweep's sinusoidal shape varies in time. The ground force measured by the array of load sensors and the pilot sweep are then directly related and are also directly related to the desired true ground force.

The true ground force, as detected by the array of load sensors or alternatively with a VSP or by some similar means and measured in step 103, is compared to the pilot sweep at step 104. If the measured ground forces are an acceptable comparison with the desired, then the original sweep is used for the survey. However, based on experience, the desired sweep and the ground force delivered are unlikely to be acceptably close. Thus, an inverse function is computed at step 107 from which a pilot modification function is derived that when applied to the pilot sweep will result in the seismic vibrator electronics driving the seismic vibrator in a manner that more closely resembles the original desired pilot sweep. Since the ground force recorded by the load sensors and the pilot sweep are directly related, it is practical to compute a time dependent transfer function by comparing the recorded true ground force data as detected by the array of load cells. The transfer function contains the information to transform the recorded true ground force data as detected by the array of load cells into the desired pilot sweep. By scaling and inverting the transfer function, a pilot modification function can be computed. By applying it to the original desired pilot sweep, a revised pilot sweep is computed that will drive the baseplate such that its motion more closely follows the original pilot sweep. Care must be taken to analyze the revised pilot sweep to assure it is reasonable and practical for the sweep to use. Basically, there are limits for the dynamics of vibrators in operation as the hydraulic system for driving the reaction mass has practical limits on the accelerating forces. Hydraulic cavitation can be very destructive along with circumstances where the reaction mass is banging into travel stops on the guide rods 21. If the revised sweep calls for actions that exceed the limits of the vibe, it must be modified, preferably as minimally as possible, to match the known abilities of the seismic vibrator.

The pilot modification function will modify the pilot sweep in the basic attributes that create a sinusoidal function. These are rate of frequency change with time, rate of phase change with time and rate of amplitude change with time. As these factors are altered in the pilot sweep the changes will be directly reflected in the motion of the baseplate when the seismic vibrator is activated using the modified sweep. It should be understood that the vibrator electronics uses feed back loops that utilize accelerometer data from accelerometer sensors placed on the vibrator reaction mass and baseplate. The vibrator electronics has algorithms programmed in that protect the vibrator from unreasonable motions that could damage the vibrator or from exceed its capability to respond.

It may be necessary to smooth or reduce the rate of change of some of the attributes that the pilot modification function is designed to modify in the desired pilot sweep. This could be as simple as smoothing the rate of change in the sinusoidal amplitude or as complex as limiting the rate of change in the frequency as a function of the rate of change of the phase.

Each of the individual vibes that are used in the fleet of vibes for a survey will have this sweep correction procedure performed. It should be understood that the sweeps that are loaded onto the vibes are unlikely to be the same, especially when considering that there are many vibes made by a number of companies. There are several manufacturers of seismic vibrators including Industrial Vehicles International, Inc. (“IVI”), Sercel, Inc. (“Sercel”) and ION Geophysical Corporation (“ION”). For example, IVI has the Hemi 60™ and Sercel has the NOMAD 65™. There are also several manufactures of vibrator electronics that can be utilized. Vibe controllers such as Sercel's 464 and 432 controllers, ION's VibePro, I/O′s Advance 2, and Seismic Sources Force 2 are just several available systems that have been tested. Each combination of a vibrator and a vibrator control electronic system has a unique response to a pilot sweep. Additionally, as noted above, the material under the baseplate alters the response of the vibrator system to the pilot sweep. However, in the end, it is desired that all of the ground forces applied by the individual vibes will be roughly equivalent so that the data records will not be skewed by large variations in ground force applications at the various shot or source points in the survey or survey area.

As is seen by the number of seismic vibrator manufactures and the number of seismic vibrator electronic controllers, there are multiple combinations that will yield equipment combinations with unique ground force characteristics of delivering ground force into the earth. This invention can be used to determine the ground force characteristics of a vibrator and vibrator electronic controller combination under standardized controlled field conditions and then the resulting characteristics can be managed within the vibrator control systems that are updated pursuant to the teachings of the present invention. For example, the controller may be updated to alter the vibrator or the control algorithms to provide options for operating the vibe in a conventional manner, in a true ground force mode of operation and may accommodate inputs for future calibration of the equipment as wear and part replacement changes the performance of the vibrator to take a pilot sweep and deliver the desired ground force. The calibration may be performed under standardized field conditions or may be performed for particular applications for specific surveys.

In an alternative embodiment, the true ground force imparted to the earth from a seismic vibrator guided by a desired pilot sweep is recorded using a load sensor device or an array of load sensor devices. The seismic vibrator controller electronics is supplied a pilot sweep that represents the desired source signature.

The true ground force as detected by the array of load sensors is compared to the pilot sweep and an inverse function is computed from which a pilot modification function is derived that when applied to the original pilot sweep will result in the seismic vibrator electronics driving the seismic vibrator in a manner that more closely resembles the original desired pilot sweep.

The pilot modification function is analyzed for suitability for use with the seismic vibrator. If necessary, the pilot modification function attributes are modified and a new pilot modification function created and it analyzed. This loop is repeated doing the minimal modifications possible to create a pilot modification function that is suitable for the seismic vibrator.

The pilot modification function is applied to the original pilot sweep to create a 1^{st} revised pilot sweep. The 1^{st} revised pilot sweep is analyzed for suitability with the vibrator. If it is found not to be suitable the 1^{st} revised pilot sweep is modified if applicable to the incompatibility issue and a new 1^{st} revised pilot sweep is generated.

If the pilot modification function is applied to the original pilot sweep and it is determined that the resulting 1^{st} revised pilot sweep cannot be modified to remove an incompatibility issue with the vibrator then the pilot modification function is re-examined and the 1^{st} revised pilot sweep generation process is repeated from the pilot modification function creation step. This loop continues until a 1^{st} revised pilot sweep is found that is suitable for use with the vibrator.

The 1^{st} revised pilot sweep is supplied to the seismic vibrator control electronics. The source is activated using the 1^{st} revised pilot sweep with the load sensor or array of load sensors positioned under the base plate. The resulting true ground force as detected by the load sensors is recorded.

The true ground force as detected by the array of load sensors is compared to the original desired pilot sweep and an inverse function is computed from which a pilot modification function is derived.

The pilot modification function is analyzed for suitability for use with the seismic vibrator. If necessary the pilot modification function attributes are modified and a new pilot modification function created and it analyzed. This loop is repeated doing the minimal modifications possible to create a pilot modification function that is suitable for the seismic vibrator.

The pilot modification function is applied to the 1^{st} revised pilot sweep to create the 2^{nd} revised pilot sweep. The 2^{nd} revised pilot sweep is analyzed for suitability with the vibrator. If it is found not to be suitable the 2^{nd} revised pilot sweep is modified if applicable to the incompatibility issue and a new 2^{nd} revised pilot sweep is generated.

If the pilot modification function is applied to the 1^{st} revised pilot sweep and it is determined that the resulting 2^{nd} revised pilot sweep cannot be modified to remove an incompatibility issue with the vibrator then the pilot modification function is reexamined and the 2^{nd} revised pilot sweep generation process is repeated from the pilot modification function creation step. This loop continues until a 2^{nd} revised pilot sweep is found that is suitable for use with the vibrator.

The 2^{nd} revised pilot sweep is supplied to the seismic vibrator control electronics. The source is activated using the 2^{nd} revised pilot sweep with the load sensor or array of load sensors positioned under the base plate. The resulting true ground force as detected by the load sensors is recorded.

The true ground force as detected by the array of load sensors is compared to the original pilot sweep. If the error between the true ground force as measured and the desired original pilot sweep is found to be at too high of a level to accept then the loop of revising the pilot sweep continues by using the 2^{nd} revise pilot sweep as with the loop that started with the 1^{st} revised pilot sweep being supplied to the seismic vibrator. The loop is repeated to create a 3^{rd} revised pilot sweep or is repeated until the error between the true ground force as measured and the desired original pilot sweep is found to be at an acceptable level.

If the error between the true ground force as measured and the desired original pilot sweep is found to be at an acceptable level the final revised pilot sweep that satisfied the error condition is supplied to the vibrator electronics for use in mass production. The supplied final revised pilot sweep is termed the true ground force sweep since it creates a ground force that matches or closely matches that embodied in the desired original pilot sweep. If the error between the true ground force as measured and the desired original pilot sweep is found to be not at an acceptable level, then the vibe is taken offline and repaired until it is capable of producing the appropriate sweep. Alternatively, the pilot sweep is modified and the process is started over again.

In an embodiment, the method further comprises repeating these steps, as discussed in the previous paragraphs, until an optimized true ground force sweep is obtained; and entering the optimized true ground force sweep into the first vibrator controller electronics.

In an embodiment, for operation of a plurality of seismic vibrators on a project, the method further comprises matching a second seismic vibrator and second electronic vibrator controller to the optimized true ground force sweep of the first seismic vibrator and the first vibrator controller electronics. Accordingly, a plurality of seismic vibrators and vibrator controller electronics may be matched to the optimized true ground force sweep of the first seismic vibrator and the first vibrator controller electronics by running each vibe through the invention and determine its particular true ground force sweep and then loading the revised sweep into the vibes sweep controller to maximize similarity of the ground forces delivered by each of the vibrators.

In an embodiment, the method further comprises acquiring seismic data with the true ground force sweep entered into one or more vibrator controller electronics as the new desired pilot sweep for each vibrator. Essentially, once a vibe has developed a true ground force sweep that is stable and best meets the desired geophysical result, the sweep is then loaded into the vibes electronic controller box as a custom sweep.

The present invention extends the usable bandwidth of vibrator output signal within the limits of the existing vibrator technology, and maximizes the temporal resolution of acquired seismic data.

All patents and patent applications, articles, reports, and other documents cited herein are fully incorporated by reference to the extent they are not inconsistent with this invention.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method for delivering a preferred seismic sweep from a seismic vibrator source into the ground in a survey area, where the ground force delivered by the seismic vibrator provides data with a broader bandwidth, where the method comprises:
(a) providing a first seismic vibrator having a baseplate, a baseplate drive system connected to the baseplate to move the baseplate up and down, and a vibrator controller apparatus to control the baseplate drive system;
(b) providing at least one sensing device to measure the force the baseplate applies against the ground;
(c) actuating the seismic vibrator source via the vibrator controller to deliver at least one desired original pilot sweep through the sensing device to the ground measuring and recording the actual force output of the source;
(d) comparing the actual output force to the original desired pilot sweep;
(e) creating a suitable inverse function between the recorded force data as measured by the sensing device and the desired pilot sweep by computing a pilot modification function and analyzing the pilot modification function for suitability for use with the seismic vibrator system and modifying the revised pilot sweep, if necessary, for such suitability; and
(f) using the revised pilot sweep as the standard sweep in the acquisition of seismic data in the survey area in a conventional manner without using the load sensing devices at every source location.

2. The method according to claim 1 wherein said at least one sensing device is independent of the seismic vibrator.

3. The method according to claim 1 or claim 2 wherein said at least one sensing device is located between the baseplate and the ground.

4. The method according to claim 1, further comprising performing steps (b) through (f) on all other seismic vibrator sources that take part in the seismic survey of the survey area.

5. The method according to claim 1 where in the load sensing devices comprise a plurality of load cells.

6. The method according to claim 1 further comprising the step (g) of actuating the seismic vibrator using the vibrator controller to deliver the revised pilot sweep to the ground through the load sensing device and the force delivered by the baseplate to the ground is measured and repeating steps (d) and (e) and step (g) until an error difference between the recorded force data measured by the load sensing device and the original desired pilot sweep is reduced to an acceptable level and then creating a final revised pilot sweep to be used as the standard sweep in the survey area.

7. The method according to claim 4, further comprising performing steps (b) through (f) including the repetition of steps (d), (e) and (g) on all other seismic vibrator sources that take part in the seismic survey of the survey area.

8. The method according to claim 1 wherein the sensing device is a vertical seismic profile system.

9. The method according to claim 1 wherein the sensing device is an external accelerometer.

10. The method according to claim 1 wherein the sensing device is one or more geophones.

11. The method according to claim 1, further comprising performing steps (a) through (e) on a seismic vibrator source and electronic controller combination under standardized controlled field conditions wherein the vibrator control system includes one or more algorithms to provide a standardized or calibrated ground force sweep correction based on independent measurements of true ground force delivered by the seismic vibrator.
